(19) United States
(12) Patent Application Publication
(10) Pub. No.: US 2005/0043994 A1
(43) Pub. Date: Feb. 24, 2005

(54) Method for allowing a customer to obtain a discounted price for a transaction and terminal for performing the method

(76) Inventors: Jay S. Walker, Ridgefield, CT (US); Daniel E. Tedesco, Westport, CT (US); Stephen C. Tulley, Stamford, CT (US); John M. Packes JR., Hawthorne, NY (US); Keith Bemer, New York, NY (US); James A. Jorasch, Stamford, CT (US); Russell P. Sammon, Stamford, CT (US); Michiko Kobayashi, Stamford, CT (US)

Correspondence Address: WALKER DIGITAL, FIVE HIGH RIDGE PARK, STAMFORD, CT, 06905, US

(21) Appl. No.: 10/940,853

(22) Filed: Sep. 14, 2004

Related U.S. Application Data
(63) Continuation of application No. 09/672,066, filed on Sep. 28, 2000, now abandoned.
(63) Continuation-in-part of application No. 09/219,267, filed on Dec. 23, 1998.
Application No. 09/219,267 is a continuation-in-part of application No. 08/943,483, filed on Oct. 3, 1997, now abandoned.
Application No. 08/943,483 is a continuation-in-part of application No. 08/923,683, filed on Sep. 4, 1997, now Pat. No. 6,553,346.
Application No. 08/923,683 is a continuation-in-part of application No. 08/889,319, filed on Jul. 8, 1997, now Pat. No. 6,085,169.
Application No. 08/889,319 is a continuation-in-part of application No. 08/707,660, filed on Sep. 4, 1996, now Pat. No. 5,794,207.
(63) Continuation-in-part of application No. 09/100,684, filed on Jun. 19, 1998.
Application No. 09/100,684 is a continuation-in-part of application No. 08/982,149, filed on Dec. 1, 1997, now Pat. No. 6,196,458.
(63) Continuation-in-part of application No. 08/994,426, filed on Dec. 19, 1997, now Pat. No. 6,694,300.
Application No. 08/994,426 is a continuation-in-part of application No. 08/920,116, filed on Aug. 26, 1997, now Pat. No. 6,119,099.
Application No. 08/920,116 is a continuation-in-part of application No. 08/822,709, filed on Mar. 21, 1997, now Pat. No. 6,267,670.
(63) Continuation-in-part of application No. 09/526,907, filed on Mar. 16, 2000.
(63) Continuation-in-part of application No. 09/219,267, filed on Dec. 23, 1998.
(60) Provisional application No. 60/143,490, filed on Jul. 12, 1999.

(51) Int. Cl. G06F 17/60

(52) U.S. Cl. 705/14

(57) ABSTRACT

A pricing terminal is installed at a retail store. The pricing terminal includes an enclosure that allows a customer to be seated therein, a display screen mounted in the enclosure, a keyboard and a processor operatively connected to the display screen and the keyboard. The processor is programmed to control the display screen, receive input via the keyboard and guide the customer to perform a pricing activity. The pricing activity may include viewing an advertisement, answering survey questions, or agreeing to enter into a transaction with a third party. The customer is rewarded for performing the pricing activity by receiving a discount on a purchase transaction or another benefit.

### CROSS-REFERENCE TO RELATED APPLICATIONS

This is a continuation-in-part of co-pending provisional patent application Ser. No. 60/230,676, filed Sep. 7, 2000; this is also a continuation-in-part of co-pending U.S. patent application Ser. No. 09/219,267, entitled “METHOD AND APPARATUS FOR FACILITATING ELECTRONIC COMMERCE THROUGH PROVIDING CROSS-BENEFITS DURING A TRANSACTION” to Jay S. Walker et al. filed on Dec. 23, 1998, which is a continuation-in-part application of co-pending U.S. patent application Ser. No. 08/943,483 entitled “SYSTEM AND METHOD FOR FACILITATING ACCEPTANCE OF CONDITIONAL PURCHASE OFFERS (CPOs)” to Andrew S. Van Luchene, Daniel E. Tedesco, James A. Jorasch, Jay S. Walker and Thomas M. Sparico filed on Oct. 3, 1997, which is a continuation-in-part of co-pending U.S. patent application Ser. No. 08/923,683 entitled “CONDITIONAL PURCHASE OFFER (CPO) MANAGEMENT SYSTEM FOR PACKAGES” to Andrew S. Van Luchene, Daniel E. Tedesco, James A. Jorasch, Jay S. Walker and T. Scott Case filed Sep. 4, 1997, which is a continuation-in-part of U.S. patent application Ser. No. 08/889,319 entitled “CONDITIONAL PURCHASE OFFER MANAGEMENT SYSTEM” to Bruce Schneier, James A. Jorasch, Jay S. Walker and T. Scott Case filed Jul. 8, 1997, which is a continuation-in-part of U.S. Pat. No. 5,794,207 entitled “METHOD AND APPARATUS FOR A CRYPTOGRAPHICALLY ASSISTED COMMERCIAL NETWORK SYSTEM DESIGNED TO FACILITATE BUYER-DRIVEN CONDITIONAL PURCHASE OFFERS” issued to Bruce Schneier, James A. Jorasch and Jay S. Walker on Aug. 11, 1998; and a continuation-in-part of co-pending U.S. patent application Ser. No. 09/100,684 entitled “BILLING STATEMENT CUSTOMER ACQUISITION SYSTEM” to Daniel E. Tedesco, James A. Jorasch and Jay S. Walker filed on Jun. 19, 1998, which is a continuation-in-part of co-pending U.S. patent application Ser. No. 08/982,149 entitled “METHOD AND APPARATUS FOR PRINTING A BILLING STATEMENT TO PROVIDE SUPPLEMENTARY PRODUCT SALES” to Jay S. Walker, Daniel E. Tedesco, Andrew S. Van Luchene and Dean P. Alderucci filed on Dec. 1, 1997; and a continuation-in-part of co-pending U.S. patent application Ser. No. 08/994,426 entitled “METHOD AND APPARATUS FOR PROVIDING SUPPLEMENTARY PRODUCT SALES TO A CUSTOMER AT A CUSTOMER TERMINAL” to Jay S. Walker, Andrew S. Van Luchene and Daniel E. Tedesco filed on Dec. 19, 1997, which is a continuation-in-part of co-pending U.S. patent application Ser. No. 08/920,116 entitled “METHOD AND SYSTEM FOR PROCESSING SUPPLEMENTARY PRODUCT SALES AT A POINT-OF-SALE TERMINAL” to Jay S. Walker, James A. Jorasch and Andrew S. Van Luchene filed on Aug. 26, 1997, which is a continuation-in-part of co-pending U.S. patent application Ser. No. 08/822,709 entitled “SYSTEM AND METHOD FOR PERFORMING LOTTERY TICKET TRANSACTIONS UTILIZING POINT-OF-SALE TERMINALS” to Jay S. Walker, James A. Jorasch and Sanjay K. Jindal filed on Mar. 21, 1997; the present application is also a continuation-in-part of co-pending U.S. patent application Ser. No. 09/526,907, entitled “SYSTEMS AND METHODS FOR PROVIDING A SUBSIDY OFFER THROUGH A CUSTOMER DEVICE” to Jay S. Walker et al., filed on Mar. 16, 2000, which claims the benefit of provisional U.S. patent application Ser. No. 60/143,490 filed Jul. 12, 1999 and is a continuation-in-part of U.S. patent application Ser. No. 09/219,267 entitled “METHOD AND APPARATUS FOR FACILITATING ELECTRONIC COMMERCE THROUGH PROVIDING CROSS-BENEFITS DURING A TRANSACTION” which was filed Dec. 23, 1998.

The present application is related to: U.S. patent application Ser. No. 09/282,747 entitled “Method and Apparatus for Providing Cross-Benefits Based on a Customer Activity” and filed Mar. 31, 1999; U.S. patent application Ser. No. 09/274,281 entitled “Method and Apparatus for Providing Cross-Benefits via a Central Authority” and filed Mar. 22, 1999; U.S. patent application Ser. No. 09/322,351 entitled “Method and Apparatus for Providing Cross Benefits and Penalties” and filed May 28, 1999; U.S. patent application Ser. No. 09/282,747 entitled “Method and Apparatus for Providing Cross-Benefits Based on a Customer Activity,” filed Mar. 31, 1999; U.S. application Ser. No. 09/579,215 entitled “Systems and Methods for Evaluating Information Associated with a Transaction to Determine a Subsidy Offer,” filed May 26, 2000; U.S. patent application Ser. No. 09/221,099 entitled “Pre-Sale Data Broadcast System and Method” and filed Dec. 28, 1998; and U.S. patent application Ser. No. 09/152,905 entitled “Vending Machine Method and Apparatus for Encouraging Participation in a Marketing Effort.”

The entire contents of the applications listed above are incorporated herein by reference.

### FIELD

The present invention relates to transactions in which a customer purchases an item. In particular, the present invention is concerned with apparatus and methods wherein a customer is allowed to perform activities to reduce prices for such transactions.

### BACKGROUND

Retailers often find it desirable to offer discounts to customers in order to increase sales. However, discounting tends to reduce retailers' profit margins and may condition customers not to purchase products at undiscounted prices. It would be desirable for retailers to be able to allow customers to obtain reduced prices without compromising the revenues actually received by the retailers for the products sold, or without undermining the retailers' preferred pricing structures.

Manufacturers' coupons represent one well-known discounting technique that does not reduce revenues received by retailers. However, coupons are widely recognized as being expensive and highly inefficient. Coupons are also inconvenient for the issuers of the coupons, for retailers, and for consumers as well.

### SUMMARY OF THE INVENTION

According to an aspect of the invention, a method of handling a transaction includes receiving at a pricing terminal an indication of at least one product to be included in the transaction, allowing a customer to perform a pricing activity at the pricing terminal, and determining a pricing benefit for the transaction based on the pricing activity. The indication of the at least one product may be received by scanning a bar code or by entry of alphanumeric data. The pricing activity may include viewing advertising material, or entering into a transaction with an entity other than the retailer from whom the product is to be purchased, or agreeing to enter into a transaction with such an entity. The method according to this aspect of the invention may also include the step of communicating the pricing benefit to a point-of-sale terminal or outputting a benefit code that represents the determined pricing benefit.

According to another aspect of the invention, a pricing terminal includes structure for receiving an indication of at least one product to be included in a transaction, structure for allowing a customer to perform a pricing activity, and structure for determining a pricing benefit for the transaction based on the pricing activity. The receiving structure may include a bar code scanner. The structure for allowing the customer to perform the pricing activity may include a display monitor and a keyboard and a processor connected to the display monitor and the keyboard and programmed to guide the customer in performing the pricing activity. In addition to or instead of the display monitor and the keyboard, the pricing terminal may include a touch screen.

The pricing terminal may include a communication device connected to the processor for transmitting information to an external device.

According to a further aspect of the invention, a pricing terminal includes an enclosure including a structure for allowing a customer to be seated in the enclosure, a display screen mounted in the enclosure, a keyboard, and a processor operatively connected to the display screen and the keyboard and programmed to control the display screen, receive input via the keyboard, guide the customer to perform a pricing activity, and determine a pricing benefit based on the pricing activity. The pricing terminal according to this aspect of the invention may further include structure operatively connected to the processor for entering data that identifies at least one product to be included in a transaction. Such structure may include a bar code scanner.

The enclosure of the pricing terminal may include structure for storing products selected for purchase by the customer. The enclosure may further include an entrance and a privacy structure such as a curtain or door for selectively covering the entrance. There may further be included in the pricing terminal a communication device operatively connected to the processor for transmitting data to an external device.

With the method and apparatus of the present invention, customers of retailers may be allowed to obtain discounted prices, which may make shopping more attractive to customers and may increase business volume for retailers. Customers may also find the pricing activities permitted by the present invention to be an entertaining and enjoyable enhancement of the typical shopping experience. The apparatus of the present invention is also preferably designed so that pricing activities are convenient, easy and quick for the customers.

From the point of view of retailers, the present invention is advantageous in that it allows discounts to be offered in a manner that does not tend to undermine the retailer's price structure. Third parties (sometimes referred to as “subsidizers”) may compensate retailers for pricing activities engaged in by customers thereby offsetting, in whole or in part, discounts or other benefits provided to customers by retailers in respect of pricing activities. By permitting customers to “earn” discounts through pricing activities, the present invention may increase customer traffic and sales volume at retail stores. The pricing activities may be enjoyable and entertaining, and thereby provide another attraction and reason for customers to patronize the retailer. The discounts obtained through pricing activities may also allow for retailers to target discounts to relatively price-sensitive customers, while continuing to charge full price to the less price-sensitive customers who do not engage in pricing activities.

Furthermore, the pricing terminal provided in accordance with the invention may serve as a vehicle for customers to perform check out transactions by themselves, and without the aid of store employees, thereby increasing the efficiency of the retailer and decreasing labor costs.

The present invention may also be beneficial as a marketing and promotional opportunity for third parties who advertise to, or otherwise aim to acquire, customers through pricing activities carried out by the customers. These third parties, sometimes referred to as subsidizers, are able, according to the invention, to engage in targeted one-on-one marketing to get advertising messages directly to customers, or to make offers of benefits that may induce customers to deal with the subsidizers.

### BRIEF DESCRIPTION OF THE DRAWINGS

FIG. 1 is a flow chart that provides an overview of a method provided in accordance with the invention;

FIG. 2 is a block diagram of a system provided in accordance with an aspect of the invention;

FIG. 3 is a block diagram illustration of a pricing terminal that is part of the system of FIG. 2;

FIG. 4 is a block diagram illustration of a controller that is part of the system of FIG. 2;

FIG. 5 is a tabular representation of a product database that is shown in FIG. 4;

FIG. 6 is a tabular representation of a customer database that is shown in FIG. 4;

FIG. 7 is a tabular representation of a pricing activity database that is shown in FIG. 4;

FIG. 8 is a tabular representation of a pricing benefit database that is shown in FIG. 4;

FIG. 9 is a perspective view of a pricing terminal provided according to an aspect of the invention;

FIG. 10 is a flow chart that shows details of a method carried out according to an aspect of the invention.

### DETAILED DESCRIPTION

The following definitions shall apply in this specification and in the appended claims:
benefit code: Information that may be used to indicate that a customer should receive a pricing benefit.
customer: A party that intends to purchase a product.
pricing activity: One or more of the following: entering into a transaction with a subsidizer or agreeing to do so, including applying for a credit card or transferring or maintaining a credit card balance, or recruiting friends to enter into or agree to enter into a transaction with a subsidizer; using a product or service from a subsidizer; providing or selling a product or service; providing information by entering verbal information or providing a selection of options presented for selection or responding to a question; receiving information such as viewing an advertisement or agreeing to receive information in the future; playing a game; maintaining interaction with a pricing terminal for a predetermined period of time; and undergoing a test of one's physical condition, such as a blood pressure test.
pricing benefit: A benefit that relates to the price of at least one product or to the price of a transaction.
pricing terminal: A device installed at a retail store and used for pricing activities; or a device used to browse the Internet, a personal computer or a personal digital assistant.
product: A product or service that is available for sale by a retailer.
retail price: An established price for a product.
retailer: A party that offers a product for sale.
subsidizer: A party that provides consideration that allows a customer to obtain a discounted price on a product to be purchased from a party other than the subsidizer (for example, a retailer).
subsidy: Consideration that is provided by a subsidizer to allow at least one customer to obtain at least one pricing benefit.

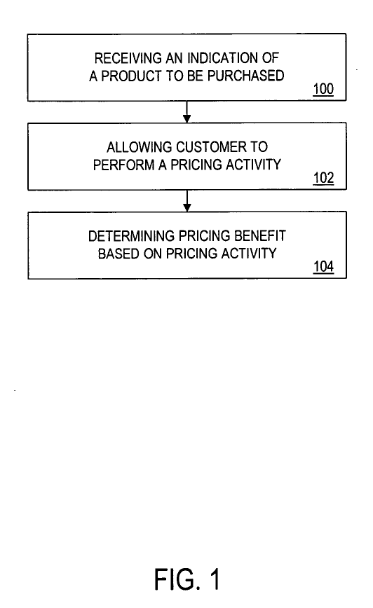

FIG. 1 illustrates a method that provides an overview of aspects of the present invention.

The method of FIG. 1 begins with a step 100 in which an indication of a product to be purchased is received at a pricing terminal. The indication of the product to be purchased may be inputted, for example, by scanning a bar code associated with the product.

Next, at step 102, a customer is allowed to perform a pricing activity at the pricing terminal.

Then, based on the pricing activity, a pricing benefit is determined (step 104).

These steps, and related steps, will be described in more detail below.

By a method as illustrated in FIG. 1, customers are allowed to earn price discounts or other benefits in a manner that does not undermine a retailer's pricing structure. Indeed, since the pricing activity may result in awarding of subsidies by third parties, the retailer may receive full price or more than full price for the customer's purchase transaction, while the customer gains a price discount and thus an incentive to buy more items and to shop more often.

System Overview

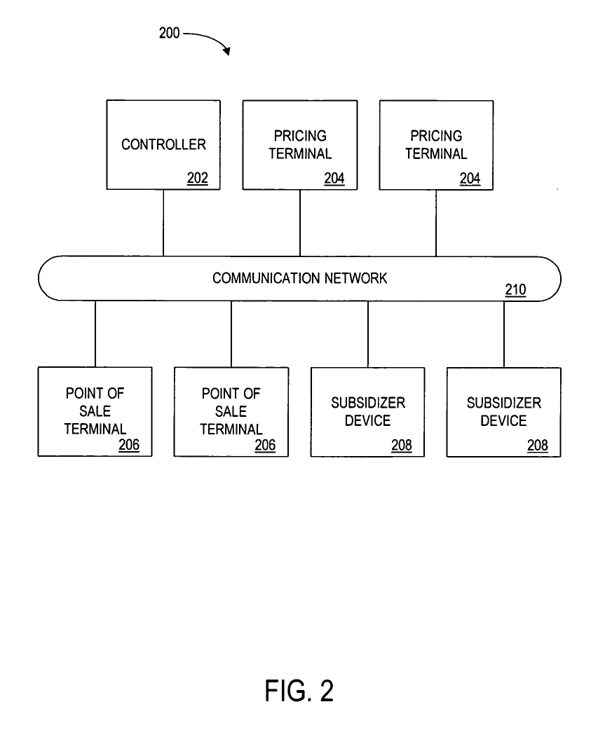

FIG. 2 is a block diagram that illustrates a system 200 provided in accordance with the invention. The system 200, as illustrated in FIG. 2, includes a controller 202, a plurality of pricing terminals 204, a plurality of point-of-sale terminals 206 and a plurality of subsidizer devices 208. Also included in the system 200 is a communication network 210 that allows for data communication among the controller 202, pricing terminals 204, point-of-sale terminals 206 and subsidizer devices 208.

It is contemplated that the number of pricing terminals included in the system 200 may be one or any other number. Furthermore, the number of point-of-sale terminals may be one or any other number. Furthermore, the pricing terminals and the point-of-sale terminals may be combined, as will be discussed below.

The number of subsidizer devices may be one or any other number, or, in one embodiment of the system 200, all subsidizer devices may be omitted.

The controller 202 and pricing terminals 204 will be described in further detail below. The point-of-sale terminals 206 may be conventional point-of-sale terminals, programmed to receive and take into consideration benefit codes to be applied during transactions carried out at the point-of-sale terminals. As is known to those who are skilled in the art, a typical point-of-sale terminal includes a processor, a memory, at least one input device such as a keyboard, a bar code reader or magnetic stripe card reader, and at least one output device, such as a display and a printer.

Each of the subsidizer devices 208 may be a personal computer, a mainframe computer or any other computer system that allows a subsidizer to communicate with the controller 202. The purpose of such communication may be for the subsidizer to indicate pricing activities to be performed at pricing terminals 204 and pricing benefits to be provided therefor.

The communication network 210 may include one or more communication networks. Among these may be the Internet, a local area network (LAN), a wide area network (WAN), a telephone line, a telecommunications cable, a radio channel, an optical communications link and a satellite communications link. The communications network 210 may employ one or more of the following communications protocols: TCP/IP, Ethernet and Bluetooth. As illustrated in FIG. 2, the communication network 210 may allow communication between the controller 202 and pricing terminals 204, between the controller 202 and subsidizer devices 208, between the controller 202 and point-of-sale terminals 206, and between pricing terminals 204 and point-of-sale terminals 206. Although the communication network 210 is illustrated as being a single network, it may be made up of a number of different networks for allowing communication between various ones of the other components of the system 200. For example, the controller may communicate with a first pricing terminal 204 using a local area network and may communicate with a second pricing terminal 204 by using the Internet.

Pricing Terminal

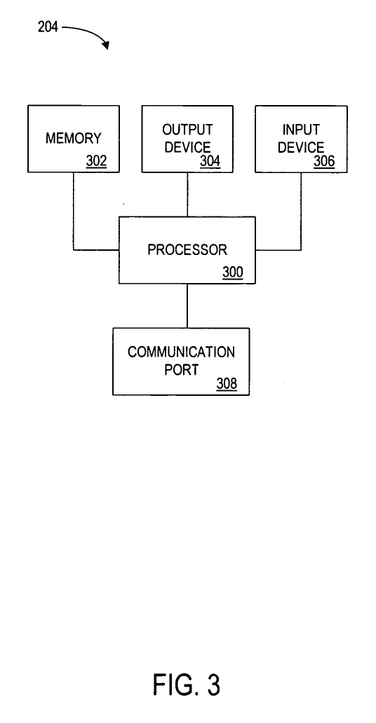

FIG. 3 is a block diagram that illustrates major electronic hardware components of a typical pricing terminal 204. As shown in FIG. 3, pricing terminal 204 includes a processor 300 connected to a memory 302, at least one output device 304, at least one input device 306, and a communication port 308. In one embodiment of the invention, the components shown in FIG. 3 may be provided and interconnected in a manner consistent with standard architecture for a personal computer. The pricing terminal 204 is provided to permit customers to perform pricing activities, such as have been mentioned above and will be described in more detail below.

The communication port 308 connects the pricing terminal 204 to the communication network 210 (FIG. 2) for data communication with the other components of the system 200. The input device 306 is used to provide input for the pricing terminal 204 and may include one or more of the following: a computer keyboard, a keypad, a computer mouse, a touch screen, a microphone, a video camera, a bar code reader, a magnetic stripe card reader, a biometric input device such as a fingerprint reader or a retinal scanner, an infrared port for communicating with another device such as a hand held customer device, and a voice recognition module.

The output device 304 is used to output information from the pricing terminal 204 and may include one or more of the following: a video monitor, a light emitting diode (LED), an audio speaker, and a printer.

The processor 300 may be a conventional microprocessor of the type used as a CPU in a personal computer. The memory 302 may include any appropriate information storage device, including combinations of magnetic storage devices such as magnetic tape and hard disk drives, optical storage devices, and semi-conductor memory devices such as random access memory (RAM) and read only memory (ROM).

The pricing terminal 204 may be embodied as a kiosk, a personal computer, or other portable device such as a personal digital assistant (PDA). The functions of a pricing terminal may also be carried out by a combination of devices working together, such as a PDA in wireless communication with a kiosk.

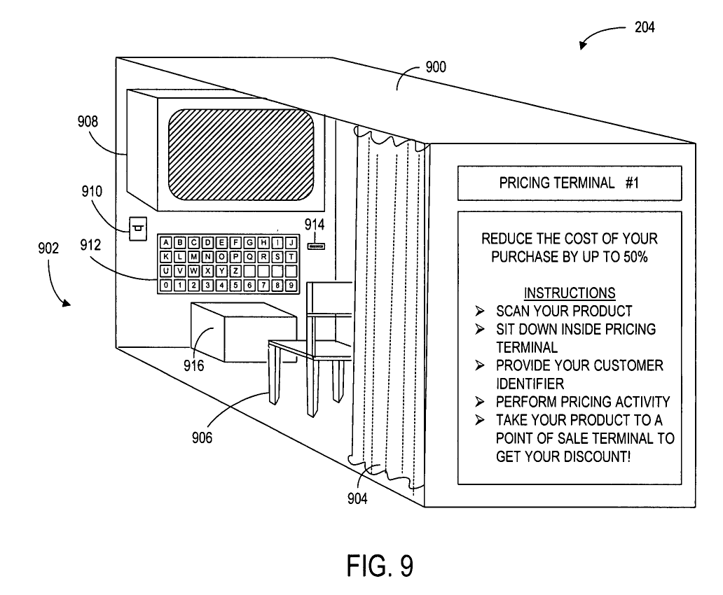

FIG. 9 illustrates the physical appearance of an embodiment of a pricing terminal 204 provided as a kiosk installed in a retail store. The pricing terminal 204 includes an enclosure or booth 900 that has an opening or door 902. A curtain 904 is arranged to be drawable across the opening 902 to provide privacy for a customer who is inside the enclosure 900. A chair 906 is positioned within the enclosure to allow a customer to be seated within the enclosure. The chair 906 is shown as being free standing, but may be replaced with a shelf or other built in structural element upon which the customer may be seated. Also installed in the enclosure 900 is a storage bin or basket 916 in which the customer may store items of merchandise that the customer intends to purchase.

Also shown as part of the pricing terminal 204 are a display screen 908 and a receipt printer 910 which function as output devices, and a keyboard 912 and a bar code reader 914 which function as input devices.

Controller

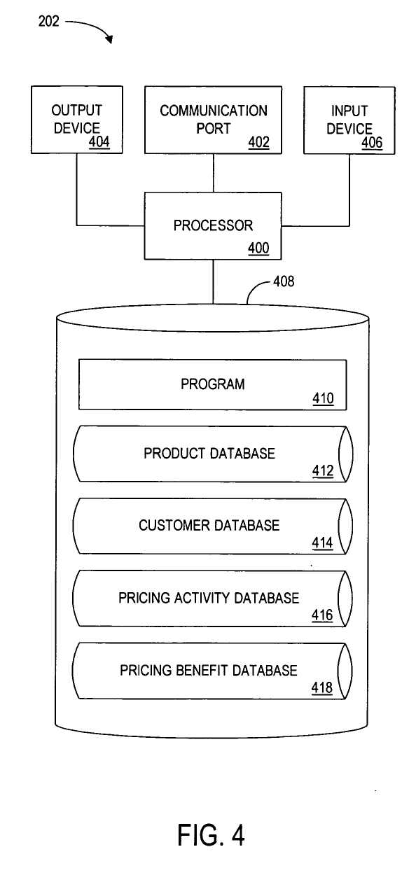

Details of the controller 202 are shown in block diagram form in FIG. 4. The hardware components of the controller 202 may be constituted by conventional computer hardware such as a mini computer or a server computer of the type employed to manage a system of POS terminals.

The controller 202 includes a processor or microchip 400 that is in communication with or otherwise uses or includes one or more communication ports 402. The communication port 402 is of the type to enable controller 202 to engage in data communication with the pricing terminals 204, the point-of-sale terminals 206 and the subsidizer devices 208. The data communication between the controller 202 and the other system components may be carried out by conventional data networking facilities, as mentioned before, such as an Ethernet local area network, a token ring type local area network, a wireless communication facility or by Internet communications.

The controller 202 also includes an output device 404 and an input device 406. Such devices may include a printer and an operator terminal with a display, keyboard and mouse.

The controller 202 further includes a storage device or devices 408 which store information, software, programs, databases, etc. The storage devices 408 preferably comprise an appropriate combination of magnetic, optical and/or semi-conductor memory and may be constituted by one or more hard disks. The processor 400 and the storage device 408 may each be, for example: (i) located entirely within a single computer or other computing device; or (ii) connected to each other by a remote communication medium, such as a serial port cable, telephone line or radio frequency transceiver.

The software and other information stored on the storage device 408 preferably includes some or all of the following: a control program 410 for operating the controller 202; a product database 412 for storing information about products sold by a retail store served by the controller 202; a customer database 414 for storing information about one or more customers who may use the system to engage in pricing activities; a pricing activity database 416, for storing information about pricing activities that may be performed by customers using the system; and a pricing benefit database 418 for storing information about pricing benefits to be provided to customers pursuant to the invention.

Each of the databases 412, 414, 416 and 418 and their use and potential data structure will be discussed in more detail below. As will be understood by those skilled in the art, the schematic illustrations and accompanying descriptions of the databases presented herein are exemplary arrangements for stored representations of information. A number of other arrangements may be employed besides those suggested by the tables shown. Similarly, the illustrated entries of the databases represent exemplary information only. Thus, those skilled in the art will understand that the number and content of the entries can be different from those illustrated herein. Not all of the databases 412, 414, 416 and 418 will be used or needed in every embodiment of the system.

The program 410 controls the processor 400. The processor 400 preferably performs instructions of the control program 410, and thereby operates in accordance with the present invention, and particularly in accordance with the methods described herein.

The program 410 may be stored in a compressed, uncompiled and/or encrypted format. The program 410 furthermore includes program elements that may be necessary such as an operating system, a database management system and device drivers for allowing the processor 400 to interface with peripheral devices, databases, etc. Appropriate program elements are known to those skilled in the art, and need not be described in detail herein. According to an embodiment of the present invention, the instructions of the program 410 may be read into a main memory from another computer-readable medium, such as the storage device 408. Execution of sequences of the instructions in the program 410 causes the processor 400 to perform the steps described herein. In alternative embodiments, hard wired circuitry may be used in place of, or in combination with, software instructions for implementation of some or all of the methods of the present invention. Thus, embodiments of the present invention are not limited to any specific combination of hardware and software.

Databases

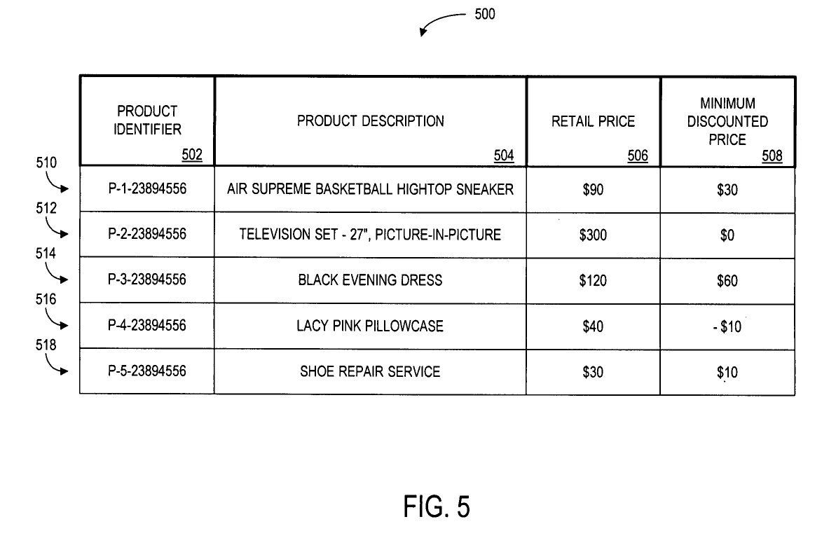

FIG. 5 shows a table 500 that is a representation of the product database 412. The table 500 includes a column 502 for storing product identifier codes, a column 504 for storing descriptions of the respective products, a column 506 for storing retail prices of the respective products, and a column 508 for storing data that indicates a minimum discounted price below which each item will not be permitted to be discounted by pricing activity. Product identifier codes are alphanumeric codes that uniquely identify products and may be indicated on the products by a bar code such as a UPC code. Minimum prices may be set to prevent customers from perceiving that a brand is lower quality due to an overly discounted price.

In the example illustrated in FIG. 5, the table 500 includes entries 510, 512, 514, 516 and 518 which respectively correspond to a pair of sneakers, a television set, an evening dress, a pillow case, and shoe repair service. It will be noted that the field corresponding to the “minimum discounted price” for entry 516 is minus $10.00, signifying that in regard to this particular product (the pillow case) a customer may be permitted to engage in pricing activity sufficient to obtain cash back of $10.00 in addition to obtaining the pillow case free of charge.

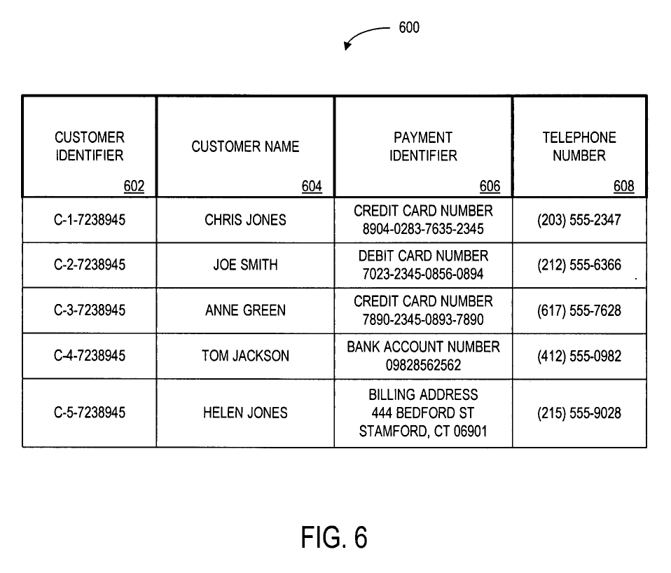

FIG. 6 shows a table 600 that represents an example of the customer database 414. Table 600 includes a column 602 that stores customer identifier codes and a column 604 that lists customer names. Also included in table 600 is a column 606 which lists for each customer payment identifier code information such as a credit card number or a bank account number. As another alternative under column 606, a billing address may be listed. A column 608 in FIG. 6 lists telephone numbers of the respective customers.

Although not shown in FIG. 6, the customer database may include additional information about customers, including address and/or other demographic information, psychographic information, purchasing history, a password, previous pricing activities, and data relating to friends or relatives of the customer.

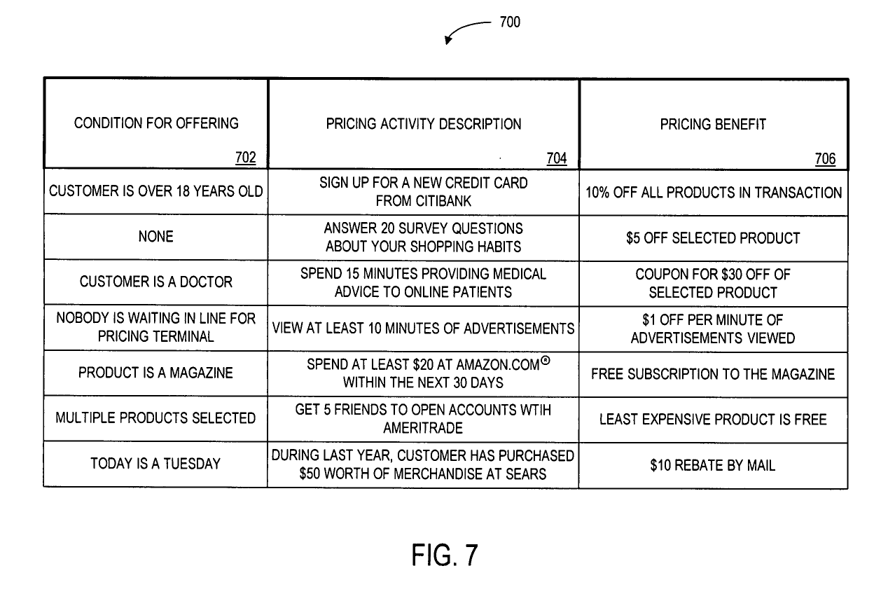

FIG. 7 shows a table 700 that illustrates the pricing activity database 416.

Table 700 includes a column 702 that lists, for each respective pricing activity, one or more conditions for determining whether the pricing activity in question should be offered. Among the conditions illustrated in column 702 are a minimum age of the customer, the customer's profession, absence of customers waiting to use the pricing terminal in question, nature of products selected for purchase by customer, number of products selected for purchase by customer, and day of the week.

Included in table 700 is a column 704 which describes corresponding pricing activities. Among the activities illustrated in FIG. 7 are signing up for a new credit card, answering survey questions, providing professional advice, viewing advertisements, agreeing to enter into a transaction in the future with a third party, agreeing to arrange for friends to open brokerage accounts, and having in the past engaged in certain transactions.

Column 706 in table 700 lists the pricing benefits which correspond to the respective pricing activities. Among the pricing benefits listed in FIG. 7 are discounts on the current transaction (denominated in dollars or percent), a coupon for a discount on a selected product, a rebate, a free magazine subscription, or the award of a selected product free of charge.

Other types of pricing activities and pricing benefits are contemplated in addition to those explicitly shown, by way of example, in FIG. 7.

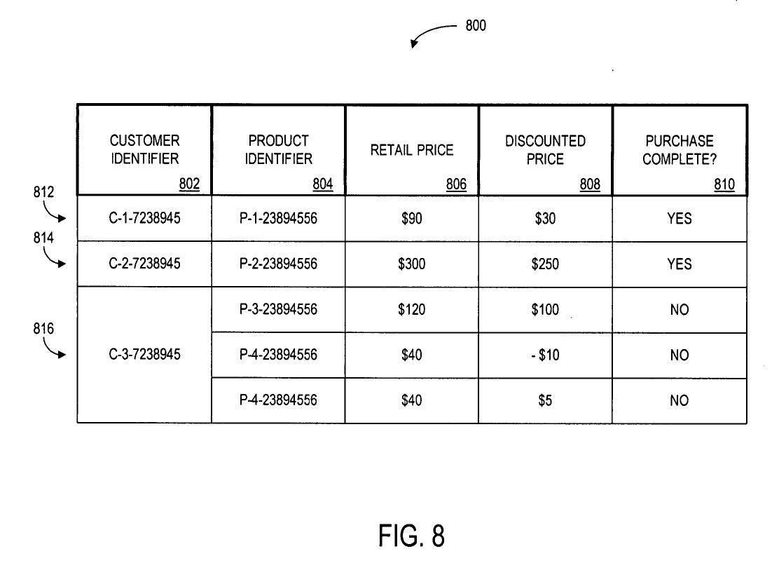

FIG. 8 shows a table 800 that illustrates an embodiment of the pricing benefit database 418.

The table 800 includes a column 802 for listing customer identifier codes, a column 804 for listing product identifier codes corresponding to products selected for purchase by the customers, a column 806 for listing the corresponding retail prices of the products identified in column 804, a column 808 which lists the discounted prices provided as pricing benefits as a result of pricing activities carried out by the customers and a column 810 which includes indications as to whether the corresponding purchase transaction has been completed.

Thus, for each customer who participates in a pricing activity, the pricing benefit database stores data indicating the products selected for purchase by the customer, the retail prices of those products, discounted prices corresponding to the pricing benefit resulting from the pricing activity, and an indication as to whether the indicated transaction has been completed and the pricing benefit granted to the customer. The entries 812, 814 and 816 shown in FIG. 8 each correspond to a respective transaction initiated by a respective customer.

Method Including Pricing Activity

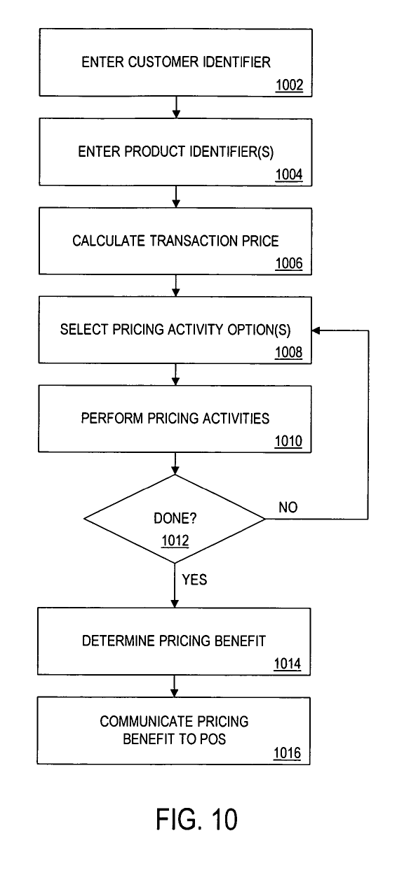

FIG. 10 is a flow chart that illustrates a method carried out in accordance with the invention by which a pricing activity is performed and a pricing benefit determined on the basis of the pricing activity.

The method of FIG. 10 begins with a step 1002 at which a customer enters into a pricing terminal a code which identifies the customer. This may be done in a number of ways. For example, the customer may swipe a magnetic stripe card, such as a shopper identification card or a credit card, through a magnetic stripe card reader that is part of the pricing terminal. Alternatively, a shopper identification card may carry a bar code that corresponds to the customer identifier, and the bar code may be scanned by a bar code reader that is part of the pricing terminal. As still another alternative, the customer may enter identifying information via a keyboard or touch screen. The identifying information may include one or more of the customer's name, the customer's telephone number, the customer's frequent shopper number or a driver's license number. As yet another alternative, the customer may log on to the terminal by using such conventional techniques as entering a user ID code and password. It is also contemplated to use speech recognition to enter the customer identifier, or to use voice recognition to identify the customer by his or her voice characteristics. Other types of biometric identification, such as a fingerprint scan or a retinal scan, may also be used. As still another alternative, the customer may provide customer identifying information orally to a store employee who then enters the information into a pricing terminal.

Alternatively, the customer may not be required to identify himself or herself. This may be appealing to customers who prefer to engage in pricing activities anonymously. However, it is preferred that customers not be anonymous to deter misuse of pricing terminals.

The customer identifier code, or other registration information entered by the customer, may be used to associate a subsequent customer purchase transaction with a pricing benefit that is earned by the customer via pricing activity. Alternatively, or in addition, previously stored or concurrently entered information regarding the customer may be used to determine what pricing activities are offered to the customer. Another useful application for customer registration information may be to send advertisements to the customer's home address, or to use such information for other marketing purposes. To the extent that the customer registration information includes one or more payment identifiers (such as credit card account numbers, debit card account numbers or financial account numbers), such information may be used to penalty-secure a customer's commitment to perform certain actions, as will be described below.

Following step 1002 is step 1004. At step 1004 the customer enters one or more product identifiers to indicate products that the customer intends to purchase. One way in which this may be done is by using a bar code scanner that may be part of the pricing terminal to scan bar code labels associated with the products. Alternatively, the product identifying codes may be keyed in using an input device such as a keyboard or touch screen and/or may be selected from a menu displayed by the pricing terminal. As still another alternative, the customer may present the product to an employee of the retail store who then uses a bar code scanner or data entry to enter into the pricing terminal signals indicative of the selected products.

Step 1006 follows step 1004. At step 1006 the pricing terminal and/or the controller 202 calculates a total price for the transaction based upon the product identifiers that have been entered. This may be done by looking up in the product database 412 retail prices that correspond to the selected products.

Following step 1006 is step 1008. At step 1008 the pricing terminal or the controller 202 operates to select one or more pricing activities that may be presented for performance by the customer. The selection of a pricing activity that is made available to the customer may be based on one or more of a number of factors. These factors may include, for example, characteristics of the customer such as customer demographic characteristics, customer purchasing history and/or pricing activities that the customer has previously performed including pricing activities performed in the current session. Another factor that may be considered in determining what pricing activity to make available to the customer may be the types of products and/or the prices of products selected for purchase by the customer. For example, if the customer has selected a camera for purchase, a pricing activity to be presented may be an opportunity for the customer to agree to purchase quantities of photographic film from a particular film manufacturer in the future in return for a reduction in the purchase price of the camera. It also may be arranged that pricing activities associated with relatively lucrative benefits may be offered in connection with purchases of expensive items.

The pricing activity may also be selected based on inventory conditions or marketing programs that are going on at the store. Environmental conditions at the pricing terminal may also be taken into account. For example, if it is determined that the store is noisy, then any pricing activity to be selected should not require the customer to listen to audio material.

Upcoming events may also affect the choice of pricing activity presented to the customer. For example, if a major sale is approaching, the customer may be presented with the pricing activity of listening to or viewing advertising relating to the sale. The pricing activity to be presented may also depend on the customer's indication of his or her own preferences in terms of pricing activities and/or associated pricing benefits. If other customers are available (i.e., logged in at other pricing terminals) then the pricing activity that is presented may be participation in a focus group.

Information available about other parties may also lead to a selection of a pricing activity to be presented to a customer. For example, if it is recognized that the customer is a parent of a small child, then the pricing activity to be presented may be answering a survey about shopping for children's clothing.

Selection of a pricing activity for presentation to a customer may be randomly determined, or may be determined based on the time of day, day of the week, day of the month, or month of the year. The number of customers to whom a particular pricing activity is presented may be limited, so that once the predetermined number of customers have performed an activity, the activity is no longer presented to any further customers. It may also be the case that the number of customers who can perform a certain pricing activity at a given time may be limited.

It is also contemplated that the selection of a pricing activity to be presented to a customer may be determined on the basis of input from a subsidizer. For example the subsidizer's input may specify an amount of a benefit and conditions to be satisfied for the pricing activity to be presented.

As another arrangement, selection of pricing activities may be randomly determined, but with a probability of selecting a particular pricing activity being weighted in favor of pricing activities sponsored by subsidizers who have paid higher amounts to the retailer.

Furthermore, selection of a pricing activity to be presented to the customer may be dependent on what pricing activities the customer has previously engaged in, either in the current session or in a prior session.

The determination of whether a pricing activity should be presented to the customer may be based on a condition like the conditions listed in column 702 of FIG. 7. The determination may be based on a single condition or on a combination of conditions.

In some cases, it may be determined that no pricing activity is to be presented to the customer. This may take place, for example, if the customer has failed to perform previous commitments that the customer has made in earlier pricing activity sessions. This may also occur if the customer and/or the customer's intended purchases do not qualify for any available pricing activities.

The pricing terminal may be arranged so that a menu of possible pricing activities is presented to the customer, and the customer is permitted to select a pricing activity from the menu. Such a menu may list with each possible pricing activity the pricing benefit associated with the pricing activity.

As another alternative, the customer may have no options to select pricing activities but instead may be required to perform whatever pricing activity is presented by the pricing terminal. If multiple pricing activities are presented to the customer, these may be performed sequentially or simultaneously.

The selection of specific pricing activities to be presented may be determined in any number of different ways and may be determined based on any number of different rules or conditions. Examples of such rules or conditions have been described above and include those listed in FIG. 7. Additional disclosure regarding rules for selecting offers to be made to a customer can be found in the above-referenced patent application Ser. No. 09/579,125.

After selection of a pricing activity, the customer proceeds to perform the selected pricing activity or activities (step 1010). The pricing activity to be performed may be any one of a number of activities that are of value to the retailer and/or to a subsidizer and for which the customer may be compensated by a pricing benefit. One possible pricing activity is receiving information, such as viewing a television commercial or other advertisement, or listening to an audio advertisement, or watching or listening to a tape concerning a public service announcement such as health information. Another pricing activity may involve agreeing to receive information such as agreeing to test drive a vehicle in the future or to attend a sales seminar.

Another category of possible pricing activity includes entering into a transaction with a third party (e.g., a subsidizer) or agreeing to do so. Such transactions may include applying for a credit card or transferring or maintaining a credit card balance, or entering into an agreement for long distance telephone service, cable television service, satellite TV service, subscribing to a magazine or other periodical, arranging for insurance coverage (life, home, automobile or casualty) or agreeing to purchase an item of merchandise from a subsidizer.

Another possible pricing activity may involve agreeing to provide or sell a product or service. For example, a pricing benefit may be awarded to a customer who commits to list an item for sale on an auction site such as eBay or on a merchandise exchange site such as priceline Perfect YardSale.

Another pricing activity may require the customer to provide information, as by responding to a survey. Still other pricing activities may entail playing a game which could be a competitive game in which the winning customer or customers receive a pricing benefit and the losing customer or customers do not. The types of games could include lotteries, games of skill and games of chance.

Another type of pricing activity may simply require the customer to maintain interaction with the pricing terminal for a predetermined period of time. Such an activity, although not inherently of value to the retailer or to any subsidizer, may provide a useful vehicle for providing discounts or other pricing benefits to customers who really need or want them, while denying discounts to customers who are not price-sensitive enough to invest their time in a pricing activity.

Still another type of pricing activity may entail undergoing or agreeing to undergo a test of the customer's physical condition, such as a blood pressure screening. This may be regarded as a form of providing information, and might lead to offers that may be provided to the customer.

To the extent that a pricing activity calls for a customer to commit to perform an action in the future, the customer's commitment may be “penalty-secured” in the sense that a penalty may be assessed against the customer if the customer fails to carry out his or her commitment or does not purchase the product or products that the customer indicated an intention to purchase. The penalty may involve, for example, reversing or denying the applicable pricing benefit, or preventing the customer from engaging in pricing activities in the future for an indefinite or definite period of time, or charging a customer's credit card account. Techniques for penalty-securing a customer's commitments to a subsidizer are disclosed in commonly assigned U.S. patent application Ser. No. 09/322,351 filed May 28, 1999 and entitled “Method and Apparatus for Providing Cross Benefits and Penalties”, the disclosure of which is incorporated by reference.

Following step 1010 is a decision block 1012, at which it is determined whether the pricing activities are complete. This determination may be made by the system (i.e., the pricing terminal and/or the controller 202), or by the customer. In any event, if it is determined at decision block 1012 that no more pricing activities are to be performed, then the process of FIG. 10 loops back to steps 1008 and 1010, as described above. However, if it is determined at decision block 1012 that pricing activities are complete, then step 1014 follows.

At step 1014 the pricing benefit to be provided to the customer as a result of the pricing activity is determined. The pricing benefit may be determined on the basis of a number of factors, including what pricing activity or activities were performed, whether the pricing activities were completed or were performed in a manner that is desired by the retailer and/or a subsidizer, and the types of products selected for purchase by the customer. It is also contemplated that the customer may be permitted to select a pricing benefit from among a number of options. Other factors that may be taken into account in determining a pricing benefit include characteristics of a customer, such as customer demographics or purchasing history, or types of pricing benefits that have previously been received by the customer. For example, customers who are considered to be particularly valuable, based on demographic or purchase history information, may be given more lucrative pricing benefits than other customers. Moreover, a pricing benefit may be prescribed according to rules such as those indicated in FIG. 7. The amount of the pricing benefit may be limited by the minimum discounted price referred to in connection with FIG. 5.

It is also contemplated that pricing benefits may be randomly determined or determined on the basis of external conditions such as weather conditions. Still other types of pricing benefits may be determined based on whether such benefits or other benefits were provided to other customers.

The pricing benefits may be of various types. For example, the pricing benefit may be a discount or reduction in price on one or more products selected for purchase by the customer, or for a transaction that includes such product or products. The discount may be denominated in a monetary amount such as dollars or in a percentage.

Another type of pricing benefit may be a rebate on the purchase of a selected product, such as a mail-in rebate certificate or an automatic rebate. Still another type of pricing benefit may be a discount or rebate on a future purchase of a selected product. For example, the customer may be given a gift certificate.

Still another type of pricing benefit may take the form of a guaranteed future price of a particular product. The guaranteed future price need not necessarily be discounted.

Another type of pricing benefit that may be provided may be an entry into a game of chance, such as a lottery ticket or a slot machine pull. If the slot machine pull results in a winning result, the customer may consequently receive another pricing benefit, such as a discount on a product.

Another type of pricing benefit may be the award of an additional item of merchandise free (e.g., an entitlement to a “buy one get one free” promotion). It is also contemplated that a customer may receive more than one pricing benefit for a given pricing activity or group of pricing activities.

Furthermore, a pricing benefit earned by a customer may be provided to a person other than the customer. For example, a customer may engage in a pricing activity to obtain a gift certificate that the customer then delivers to a friend or relative of the customer.

Following step 1014 is step 1016. At step 1016 the pricing benefit determined at step 1014 is communicated from the pricing terminal to a point-of-sale terminal. For example, the pricing benefit determined at step 1014 may be stored at the controller 202 in the pricing benefit database 418. Then, when the customer proceeds to the point-of-sale terminal, and registers at the point-of-sale terminal by means of a customer identification card or credit card, the appropriate benefit code is downloaded from the controller 202 to the point-of-sale terminal so that the pricing benefit is accorded to the customer in connection with the transaction at the point-of-sale terminal. Instead of a discount or other benefit provided at the point-of-sale terminal, the pricing benefit could be a rebate that is subsequently sent to the customer. Such a rebate could be provided directly by a subsidizer.

As another possibility, the pricing terminal may print out a ticket or paper slip with a benefit code indicative of the pricing benefit and the customer may take the ticket to a point-of-sale terminal for checkout, together with the items of merchandise selected for purchase. At the point-of-sale terminal, the ticket may be scanned, or data from the ticket (such as the benefit code) may be entered by the checkout clerk so that the customer is accorded the pricing benefit in connection with the transaction at the point-of-sale terminal.

It should be observed that the pricing terminal described herein, and the methods of the present invention introduce a new modality into the conventional shopping experience. Conventionally, a customer selects items for purchase and then proceeds directly to the checkout counter. However, with the method and apparatus of the present invention, an additional step, beneficial to the customer, the retailer and possibly third parties as well, is inserted before the process of paying for the purchases. In this new step, the customer engages in activities that cause the price of the transaction to be reduced, or otherwise convey benefits for the customer. The pricing terminal disclosed herein is a particular example of a hardware embodiment that facilitates the new modality of a pricing activity that is interpolated between the conventional steps of purchase selection and purchase payment. To the extent that the pricing activity may also be entertaining and enjoyable, it represents an enhancement to the shopping experience and an additional reason for shoppers to visit retail stores. The invention also caters to the desire of customers to avoid costs that they would otherwise incur.

It should be recognized that, in one embodiment of the invention, the pricing terminal may also serve as a point-of-sale terminal. This may occur in a variety of ways. For example, it is contemplated, although not necessarily preferred, for the customer to engage in a pricing activity such as answering survey questions at a point-of-sale terminal. A possible disadvantage of this embodiment would be the potential for delaying throughput at the point-of-sale terminal. It will be appreciated that pricing terminals provided separately from point-of-sale terminals are particularly advantageous in that pricing activities performed at such pricing terminals do not tend to cause delays during checkout operations.

According to another embodiment, a self-checkout regimen may be instituted by allowing customers to pay for their purchases at the pricing terminal. It is to be recognized that, if the customer enters product identifiers at the pricing terminal and also swipes his or her credit card at the pricing terminal; then all necessary information to perform a checkout transaction has been inputted into the pricing terminal by the customer. Upon completion of the pricing activity and determination of the pricing benefit, the customer can signal to the pricing terminal that the customer is ready to complete the transaction. At this point, a suitable transaction receipt may be printed by the pricing terminal and, at the same time, the customer's credit card account may be charged. The customer can then exit from the retail store with his or her purchases and the transaction receipt in hand.

Subsidizers also gain unique benefits from the present invention. From a subsidizer's point of view, pricing activities carried out by the customers may include targeted advertising, or may involve cross-subsidy offers in which customers agree to enter into relationships with the subsidizers, so that the subsidizers acquire new customers at the relatively low cost of pricing benefits to be underwritten by the subsidizers. The pricing activities provided pursuant to the invention may present subsidizers with advertising and customer-acquisition opportunities that are more cost effective than any available alternative.

It should also be noted that application of the method of the present invention is not limited to a physical retail store. Just as conventional on-line shopping includes the two steps of product selection followed by payment, the present invention contemplates that a pricing activity step may be inserted between these two activities when carried out on-line. Thus, the method of the present application is applicable to on-line shopping environments as well as the physical retail store setting. When the present invention is applied in the on-line environment, it is to be understood that the personal computer or other device utilized by the customer for the on-line shopping serves as a pricing terminal when used in accordance with the invention.

In embodiments of the invention described above pricing activities ere performed prior to checkout, but it is also contemplated that pricing activities be performed after checkout to qualify for rebates, coupons and so forth. Furthermore, it is not required that pricing terminals be located in retail stores themselves. For example, pricing terminals may be located in the parking lot or parking garage of a retail store or shopping mall.

The methods described herein as a sequence of steps are not limited to being performed in the order described herein, but may be performed in any order that is practical.

Although the present invention has been described with respect to preferred embodiments thereof, those skilled in the art will note that various substitutions, modifications and variations may be made with respect to the embodiments described herein without departing from the spirit and scope of the present invention.

1. A method of handling a transaction, comprising:
receiving at a pricing terminal an indication of at least one product to be included in the transaction;
allowing a customer to perform a pricing activity at the pricing terminal; and
determining a pricing benefit for the transaction based on the pricing activity.

2. The method of claim 1, wherein the indication of the at least one product is received by scanning a bar code.

3. The method of claim 1, wherein the indication of the at least one product is received by entry of alphanumeric data indicative of the at least one product.

4. The method of claim 1, wherein the product is available for sale from a retailer, and the pricing activity includes at least one of entering into a transaction with an entity other than the retailer and agreeing to enter into a transaction with an entity other than the retailer.

5. The method of claim 1, wherein the pricing activity includes viewing advertising material.

6. The method of claim 1, wherein the pricing activity includes responding to a survey.

7. The method of claim 1, further comprising the step of communicating the pricing benefit to a point of sale terminal.

8. The method of claim 1, further comprising the step of outputting a benefit code that represents the determined pricing benefit.

9. The method of claim 1, wherein the pricing benefit is a discount on the transaction.

10. The method of claim 1, wherein the pricing benefit is a discount on the at least one product.

11. A pricing terminal, comprising:
means for receiving an indication of at least one product to be included in a transaction;
means for allowing a customer to perform a pricing activity; and
means for determining a pricing benefit for the transaction based on the pricing activity.

12. The pricing terminal of claim 11, wherein the means for receiving includes a bar code scanner.

13. The pricing terminal of claim 11, wherein the means for allowing includes a display monitor and a keyboard, and a processor connected to the display monitor and the keyboard, the processor being programmed to guide the customer in performing the pricing activity.

14. The pricing terminal of claim 13, further comprising communication means connected to the processor for transmitting information to an external device.

15. The pricing terminal of claim 11, wherein the means for allowing includes a touch screen.

16. A pricing terminal, comprising:
an enclosure including means for allowing a customer to be seated in the enclosure,
a display screen mounted in the enclosure;
a keyboard; and
a processor operatively connected to the display screen and the keyboard;
the processor being programmed to:
control the display screen;
receive input via the keyboard;
guide the customer to perform a pricing activity; and
determine a pricing benefit based on the pricing activity.

17. The pricing terminal of claim 16, further comprising entry means operatively connected to the processor for entering data that identifies at least one product to be included in a transaction.

18. The pricing terminal of claim 17, wherein the entry means includes a bar code scanner.

19. The pricing terminal of claim 16 wherein the enclosure includes means for storing products selected for purchase by the customer.

20. The pricing terminal of claim 16, wherein the enclosure includes an entrance, and privacy means for selectively covering the entrance.

21. The pricing terminal of claim 16, further comprising communication means operatively connected to the processor for transmitting data to a external device.

22. The pricing terminal of claim 21, wherein the processor is programmed to transmit via the communication means data indicative of the determined pricing benefit.

23. The pricing terminal of claim 16, further comprising a printer operatively connected to the processor.

24. The pricing terminal of claim 23, wherein the processor is programmed to cause the printer to print a benefit code indicative of the determined pricing benefit.

25. The pricing terminal of claim 16, further comprising a magnetic stripe card reader operatively connected to the processor.

26. The pricing terminal of claim 16, wherein the processor is programmed to process a sales transaction based on data entered via the magnetic stripe card reader.

27. A method of handling a transaction, comprising:
entering at a pricing terminal data indicative of at least one product selected for the transaction;
performing a pricing activity at the pricing terminal; and
determining a pricing benefit for the transaction based on the pricing activity.

28. A method of handling a transaction, comprising:
receiving at a pricing terminal an indication of at least one product to be included in the transaction;
allowing a customer to perform a pricing activity at the pricing terminal; and
determining a discounted price for the transaction based on the pricing activity.

29. An article of manufacture comprising:
a computer usable medium having computer readable program code means embodied therein for handling a transaction, the computer readable program code means in said article of manufacture comprising:
computer readable program code means for receiving at a pricing terminal an indication of at least one product to be included in a transaction;
computer readable program code means for allowing a customer to perform a pricing activity at the pricing terminal; and
computer readable program code means for determining a pricing benefit for the transaction based on the pricing activity.
